(19) United States
(12) Patent Application Publication
(10) Pub. No.: US 2026/0156587 A1
(43) Pub. Date: Jun. 4, 2026

(54) SYSTEM AND METHOD FOR OPTIMIZING ENERGY CONSUMPTION FOR A WIRELESS ECOSYSTEM

(71) Applicant: GM GLOBAL TECHNOLOGY OPERATIONS LLC, Detroit, MI (US)

(72) Inventors: Ahmed F. Al Alawy, Canton, MI (US); Leo Lanctot, South Lyon, MI (US); Gaurav Talwar, Novi, MI (US)

(73) Assignee: GM GLOBAL TECHNOLOGY OPERATIONS LLC, Detroit, MI (US)

(21) Appl. No.: 18/968,232

(22) Filed: Dec. 4, 2024

(51) Int. Cl. H04W 52/38; H04W 52/02

(52) U.S. Cl. CPC H04W 52/386; H04W 52/0219

(57) ABSTRACT

A method of operating a wireless ecosystem includes connecting electronic devices that each have a wireless communications module with a wireless hub and querying the electronic devices with incremental variations in wireless hub transmission power to determine a reduced hub transmission power for the wireless hub sufficient to communicate with the plurality of electronic devices. The method also includes providing to each of the electronic devices an assigned wireless transmission power for communicating with the wireless hub and transmitting the assigned wireless transmission power from the wireless hub to each of the electronic devices for communicating with the wireless hub.

### INTRODUCTION

Electronic devices, such as Internet of Things (IoT) devices, are used with greater frequency in people's day to day lives. In some cases, electronic devices communicate wirelessly over a network or wireless connection, such has a Bluetooth connection. The ability for electronic devices to communicate wirelessly allows them to be used in areas that may not have a dedicated wired network connection. Additionally, the portability of wireless electronic devices has led them to incorporate integrated power supplies, such as battery modules. The use of wireless connections with battery modules in electronic devices allows them to be carried around freely without needing to locate a power receptacle or connect additional wires to transmit information.

### SUMMARY

Disclosed herein is a method of operating a wireless ecosystem. The method includes connecting electronic devices that each have a wireless communications module with a wireless hub and querying the electronic devices with incremental variations in wireless hub transmission power to determine a reduced hub transmission power for the wireless hub sufficient to communicate with the electronic devices. The method also includes providing to each of the electronic devices an assigned wireless transmission power for communicating with the wireless hub and transmitting the assigned wireless transmission power from the wireless hub to each of the electronic devices for communicating with the wireless hub.

In one aspect of the disclosure the method includes determining if any of the electronic devices operating at the assigned wireless transmission power are unable to communicate with the wireless hub and transmitting a revised wireless transmission power to any of the electronic devices that are unable to communicate with the wireless hub at the assigned wireless transmission power.

In one aspect of the disclosure at least one of the electronic devices communicates with the wireless hub through forming an intermediate wireless connection with another one of the electronic devices.

In one aspect of the disclosure the method includes monitoring at least one of the electronic devices for a performance metric during an operational state and dynamically adjusting the assigned wireless transmission power based on comparing the performance metric during the operational state to a predetermined threshold value.

In one aspect of the disclosure the operational state includes a phone call and the performance metric includes an audio quality.

In one aspect of the disclosure the operational state includes audio streaming and the performance metric includes a measurement of clipped audio or buffered audio.

In one aspect of the disclosure the operational state includes video streaming and the performance metric includes a measurement of clipped video or buffered video.

In one aspect of the disclosure the electronic devices include at least one battery power electronic device and at least one wired electronic device configured to receive power from a power receptacle.

In one aspect of the disclosure the assigned wireless transmission power is determined based on at least one of a type of electronic device, a location of each of the electronic devices relative to the wireless hub, and a power source for each of the electronic devices.

In one aspect of the disclosure the incremental variations include reductions by predetermined percentage in the wireless hub transmission power between sequential querying of the electronic devices.

In one aspect of the disclosure the reduced hub transmission power includes a previous one of the incremental variation in the wireless hub transmission power that resulted in a confirmation message from each of the electronic devices.

In one aspect of the disclosure connecting the electronic devices with the wireless hub includes pairing the electronic devices with the wireless hub and collecting operating parameters for each of the electronic devices.

Disclosed herein is a wireless hub. The wireless hub includes a housing, a wireless communication module located within the housing and a controller located within the housing and in electrical communication with the wireless communication module. The controller is configured to connect electronic devices that each have a wireless communications module with a wireless hub and query the electronic devices with incremental variations in wireless hub transmission power to determine a reduced hub transmission power for the wireless hub sufficient to communicate with the electronic devices. The controller is also configured to provide to each of the electronic devices an assigned wireless transmission power for communicating with the wireless hub and transmit the assigned wireless transmission power from the wireless hub to each of the electronic devices for communicating with the wireless hub.

Disclosed herein is a vehicle. The vehicle includes a body at least partially defining a passenger compartment that is supported by wheels and a wireless hub located within the body and configured to communicate with electronic devices within or surrounding the vehicle. The wireless hub includes a controller configured to connect electronic devices that each have a wireless communications module with a wireless hub and query the electronic devices with incremental variations in wireless hub transmission power to determine a reduced hub transmission power for the wireless hub sufficient to communicate with the electronic devices. The controller is also configured to provide to each of the electronic devices an assigned wireless transmission power for communicating with the wireless hub and transmit the assigned wireless transmission power from the wireless hub to each of the electronic devices for communicating with the wireless hub.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a schematic illustration of an example vehicle incorporating a wireless ecosystem according to this disclosure.

FIG. 2 is a schematic illustration of the wireless ecosystem of FIG. 1.

FIG. 3 is a flow diagram of an example method of optimizing wireless power transmission in the wireless ecosystem of FIG. 1.

FIG. 4 is a flow diagram of an example method of adjusting the wireless power transmission of the wireless ecosystem of FIG. 1 based on an operating state of at least one wireless electronic device in the wireless ecosystem.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

The use of connected electronic devices, such as Internet of Things (IoT) devices has become increasingly common. These devices have many uses including communicating with others, consuming media, or tracking objects, such as in a warehouse. Because of these devices' ability to connect wirelessly to other devices, such as a wireless hub, they may be battery powered. However, communicating wirelessly can quickly drain a battery. One feature of this disclosure is to improve the battery life of connected devices while maintaining a high standard of operation that allows the connected device to operate as intended.

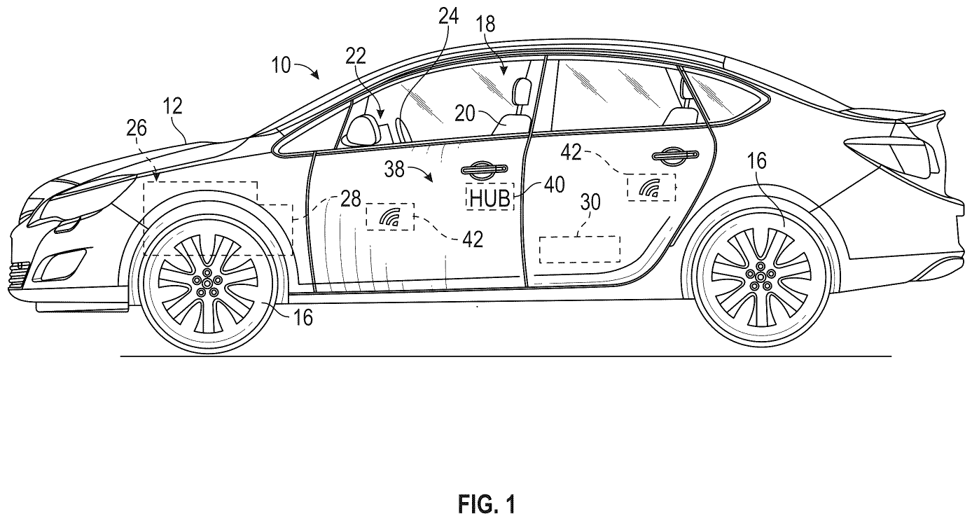

FIG. 1 illustrates a vehicle 10 incorporating a wireless mesh 38 in accordance with a non-limiting example of this disclosure. As shown in FIG. 1, the vehicle 10 includes a body 12 supported on wheels 16 with one or more of the wheels 16 being steerable. The body 12 defines, in part, a passenger compartment 18 having seats 20 positioned behind a dashboard 22. A steering control 24 is arranged between the seats 20 and the dashboard 22. The steering control 24 is operated to control orientation of the steerable wheel(s) 16.

The vehicle 10 includes an electric motor 26 connected to a transmission 28 that provides power to one or more of the wheels 16. A rechargeable energy storage system (RESS) 30 is arranged in the body 12 and provides power to the electric motor 26. However, the location of the electric motor 26, the transmission 28, and the RESS 30 relative to the body 12 may vary from those illustrated in FIG. 1.

In the illustrated example, the wireless ecosystem 38 includes a hub 40 and multiple electronic devices 42, such IoT devices, which communicate directly or indirectly with the hub 40 through a wireless connection, such as Bluetooth. In this disclosure, the electronic devices 42 can include mobile devices, tablets, computers, surveillance devices, location trackers, etc.

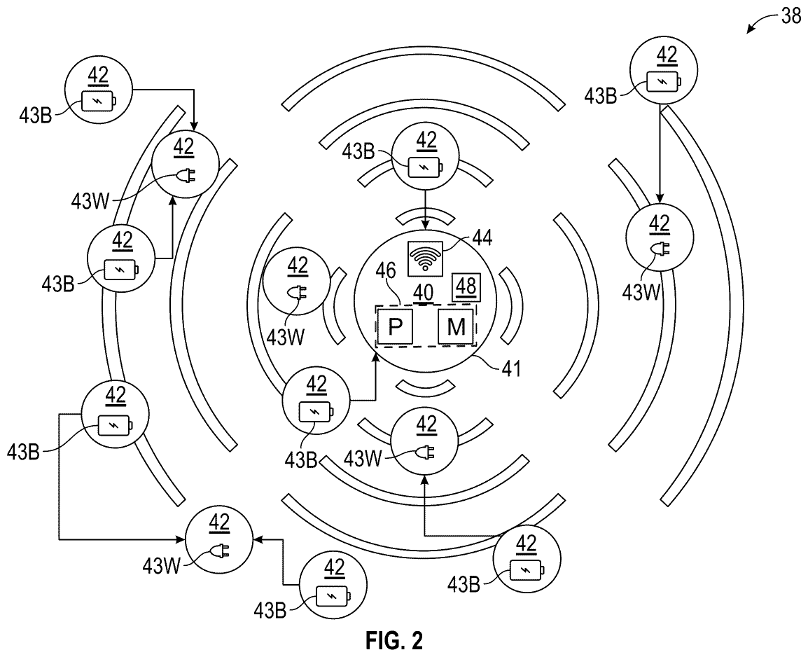

FIG. 2 is a schematic illustration of the wireless ecosystem 38 according to a non-limiting example of this disclosure. The wireless ecosystem 38 includes a wireless hub 40 that is configured to connect or pair with a multiple electronic devices 42 in the wireless ecosystem 38. The wireless hub 40 includes a housing 41 a user interface 48 and a wireless communications module 44 in electrical communication with a controller 46, such as electronic control unit (ECU), for performing the method 100 described below.

In this disclosure, the controller 46 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock. The ECU also includes an associated non-transitory computer-readable storage medium, i.e., memory (M) inclusive of read only, programmable read only, random access, a hard drive, etc., whether resident, remote or a combination of both.

Each of the electronic devices 42 include a wireless communications module that directly or indirectly communicates with the hub 40. A first set of the electronic devices 42 are battery powered 43B and a second set of the electronic devices 42 are powered by a wired power supply 43W, such as a power receptacle found in a residential or commercial building. As discussed in greater detail below, this disclosure seeks to extend the operating life of electronic devices 42, which is battery powered 43B by optimizing wireless transmission power for those devices.

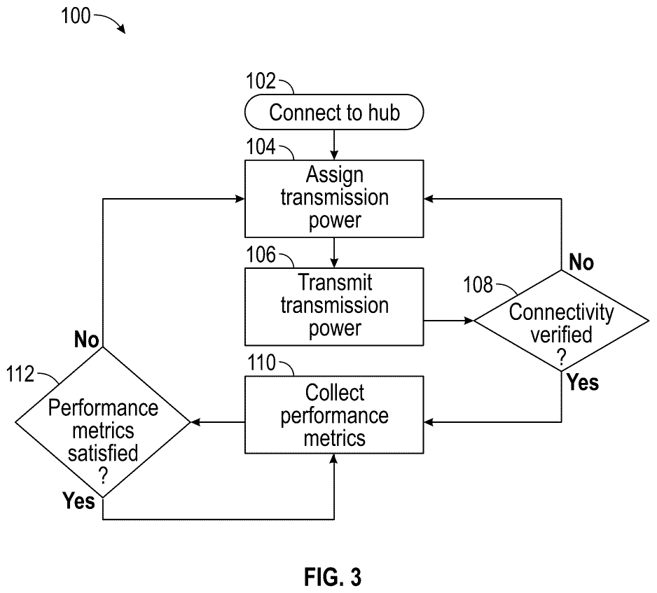

FIG. 3 illustrates a method 100 of operating the wireless ecosystem 38 to maximize battery life of the electronic devices 42 that are battery powered 43B. The method 100 begins at block 102 (“Connect to Hub”) with the electronic devices 42 being connected with the wireless hub 40. In one example, the electronic devices 42 are connected to the wireless hub 40 through a pairing process, such as a Bluetooth pairing process. The pairing process begins with the electronic devices 42 being placed in a discovery mode and the wireless hub 40 scanning for nearby Bluetooth devices in discovery mode. Once the wireless hub 40 identifies the available electronic devices 42 for pairing, a user can select the desired electronic devices 42, such as through the user interface 48 on the wireless hub 40. When the electronic devices are being paired with the wireless hub 40, operating parameters, such as power source (wired vs. wireless), purpose of the device, and Bluetooth specifications of the electronic device 42, are transferred to the wireless hub 40. This information can be stored in the memory M of the wireless hub 40.

Additionally, once the wireless hub 40 is paired to each of the electronic devices 42, the method 100 optimizes a wireless hub transmission power. The wireless hub transmission power is optimized by querying the electronic devices 42 with incremental variations or reduced wireless hub transmission power until a hub wireless transmission power is reached where the wireless hub is unable to communicate with one of the electronic devices 42. The method 100 can then select the previous wireless hub transmission power that allowed each of the electronic devices 42 to communicate with the wireless hub 40. In one example, the incremental variation includes a sequential querying with a reduction transmission power being a predetermined percentage, such as 50 percent. One feature of optimizing the wireless hub transmission power is to reduce interference caused by transmitting wireless signals from the wireless hub 40 at a distance greater than needed to communicate with each of the electronic devices 42. With the electronic devices 42 paired and the hub transmission power optimized, the method 100 proceeds to block 104.

At block 104 (“Assign Transmission Power”), the wireless hub 40 determines a wireless transmission power to assign to each of the electronic devices 42 in the wireless ecosystem 38. The assigned wireless transmission power assigned for each of the electronic devices 42 is determined based on several different parameters, such as at least one of a device type, whether the device is battery power or is directly wired to a power supply, or a location of the device relative to the wireless hub 40. Additionally, the assigned wireless transmission power can be determined based on a battery capacity or ease of replacing or charging the battery. In one example, the wireless hub 40 can apply a value or utilize a scaling factor for each of the parameters identified to determine a score for determining the wireless transmission power to assign to the electronic device 42.

As shown in FIG. 2, a first set of electronic devices 42 includes the wired power supply 43W and a second set of electronic devices 42 that are battery powered 43B. When the electronic devices 42 include the wired power supply 43W, the assigned wireless transmission power may remain at an elevated or highest wireless transmission power available because extending battery life of the wired device is not of a concern. However, the method 100 may still reduce the wireless transmission power for the wired devices to reduce transmission interference caused by having the wireless transmission power greater than is needed to communicate with the wireless hub 40.

When the electronic devices 42 are battery powered 43B, the method 100 attempts to reduce the wireless transmission power it expends to extend battery life. When the method 100 is assigning the wireless transmission power to the electronic devices 42 that are battery powered 43B, the method 100 can utilize one of the electronic devices 42 with the wired power supply 43W to act as an intermediary when communicating with the wireless hub 40. As shown by the arrows in FIG. 2, the electronic devices 42 that are battery powered 43B may communicate wirelessly with one of the electronic devices 42 having the wired power supply 43W to reduce a transmission distance when battery powered.

In this example, the method 100 may assign a wireless transmission power to one of the electronic devices 42 that is battery powered that is insufficient to reach the wireless hub 40 but can reach one of the electronic devices 42 with the wired power supply 43W located adjacent thereto through forming an intermediate wireless connection. The electronic device 42 with the wired power supply 43W can then relay the communication to the wireless hub 40. This allows the electronic device 42 that are battery powered 43B to operate for longer periods of time without requiring maintenance to replace or recharge batteries. With the wireless transmission power assigned to each of the electronic devices 42, the method can then proceed to block 106.

At block 106 (“Transmit Transmission Power”), the method 100 utilizes the wireless hub 40 to transmit the assigned wireless transmission powers to each of the electronic devices 42. The electronic devices 42 receiving the assigned wireless transmission power can then modify the transmission power of their respective wireless transmission modules to transmit at the assigned wireless transmission power. With the electronic devices 42 operating at the assigned wireless transmission powers, the method 100 can then proceed to block 108.

At block 108 (“Connectivity Verified?”), the method 100 verifies that each of the electronic devices 42 can communicate with the wireless hub 40 at the assigned wireless transmission power. As discussed above, one feature of this disclosure is to allow the electronic devices 42 to communicate with the wireless hub 40 through either a direct wireless connection or through utilizing another one of the electronic devices 42 to relay the communication to the wireless hub 40.

In one example, each of the electronic devices 42 transmits a confirmation message to the wireless hub 40 at the assigned wireless transmission power. If the wireless hub 40 does not receive the confirmation message from each of electronic devices 42, the method 100 returns to block 104 and determines a revised wireless transmission power for the electronic device(s) 42 that the wireless hub 40 from which the confirmation message was not received. The method 100 then proceeds to blocks 106 and 108 as described above to transmit the revised wireless transmission power and verify communication from each of the electronic devices 42. The method 100 continues this approach until the wireless hub 40 receives a confirmation message from each of the electronic devices 42. When the wireless hub 40 verifies connectivity with each of the electronic devices 42, the method 100 proceeds to block 110.

At block 110 (“Collect Performance Metrics”), the method 100 collects performance metrics and device analytics from at least one of the electronic devices 42. For some of the electronic devices 42 that transmit infrequently, it may not be needed to collect and monitor performance metrics, but for other devices, such as ones that transmit audio or video, it may be needed to collect and monitor performance metrics. With the performance metrics collected, the method 100 proceeds to block 112.

At block 112 (“Performance Metrics Satisfied?”), the method 100 determines if the performance metrics collected satisfy predetermined threshold values. By analyzing the performance metrics, the method 100 can make determinations if the method 100 needs to return to block 104 to dynamically adjust the wireless transmission power for the electronic device 42 being monitored. In particular, monitoring the performance metrics and device analytics for at least one of the electronic devices 42 ensures that the given electronic devices 42 is meeting predetermined performance metrics to ensure that a desired quality of communication is occurring between the given electronic device 42 and the wireless hub 40.

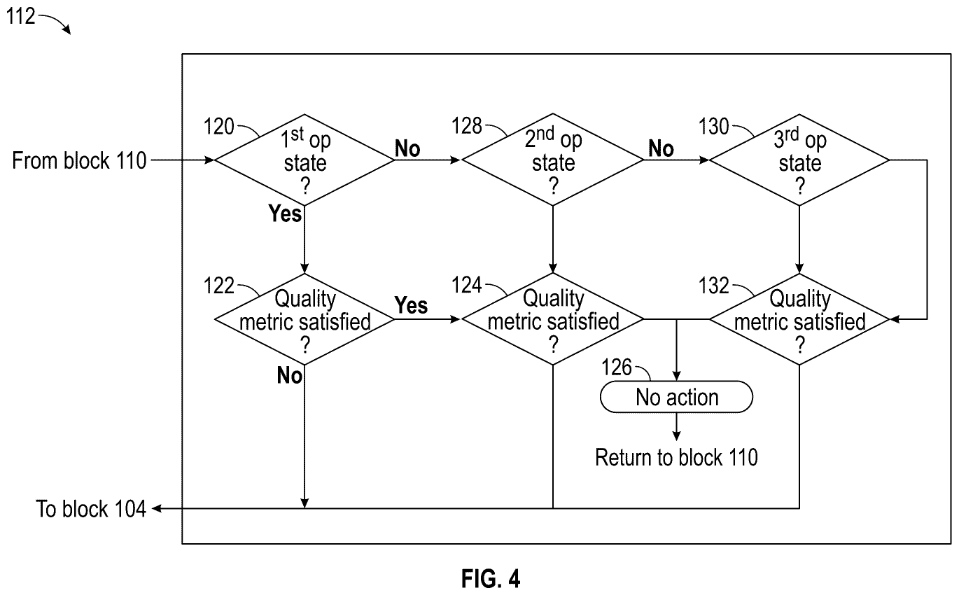

FIG. 4 illustrates an expanded flow diagram for determining if the performance metrics collected at block 110 are satisfied at block 112 by evaluating rulesets and analytics for the given electronic device 42. In one example, the ruleset and analytics can include a usage history and power dissipation analytics for the electronic device 42.

As shown at block 120 (“First Operational State?”), the method 100 determines if the electronic device 42 is operating in a first operational state based on information received from block 110. In one example, the first operational state includes the electronic device 42 performing a hands-free phone call. If the electronic device 42 is operating in the first operation state, the method 100 proceeds to block 122.

At block 122 (“Quality Metric Satisfied?”), the method 100 determines if a quality metric corresponding to the first operational state is satisfied. In one example, the quality metric for block 122 includes a quality of service (QoS) for the hands-free phone call being made on the electronic device 42. If the quality metric is at or above a predetermined threshold value, such as a QoS of 4, the method 100 proceeds to block 124.

At block 124 (“Quality Metric Satisfied?”), the method 100 determines if a second quality metric corresponding to the first operational state is satisfied. In one example, the quality metric for block 124 includes determining if the audio is clipped or buffered. If the audio corresponding to the first operational state at block 120 is not clipped or buffered, the method 100 proceeds to block 126 (“No Action”) and takes no action to change an operating parameter, such as transmission power, or ruleset for the electronic device 42. The method 100 then returns to block 110 to continue monitoring the performance metrics.

If neither of the quality metrics from blocks 122 or 124 are satisfied, the method 100 returns to block 104 and determines if changes to the wireless transmission power needs to be dynamically adjusted or if the ruleset for the wireless device 42 need to be changed. The ruleset may include information regarding how the transmission power may be varied for the electronic device 42 under certain operating conditions.

If the first operational state is not occurring at block 120, the method 100 proceeds to block 128. At block 128 (“Second Operational State?), the method 100 determines if the electronic device 42 is operating in a second operational state. In one example, the second operational state includes the electronic device 42 streaming audio. If the electronic device 42 is operating in the second operation state, the method 100 proceeds to block 124. As described above, if the quality metric of block 124 is being satisfied, the method 100 proceeds to block 126 and takes no action. The method 100 then returns to block 110 to continue to collect performance metrics for the electronic devices. If the quality metric of block 124 is not satisfied, the method 100 will return to block 104 and determines if changes to the wireless transmission power needs to be dynamically adjusted or if the ruleset for the wireless device 42 need to be changed.

If the first and second operational states are not occurring for the given electronic device 42, the method 100 proceeds to block 130. At block 130 (“Third Operational State?), the method 100 determines if the electronic device 42 is operating in a third operational state. In one example, the third operational state includes the electronic device 42 streaming video. If the electronic device 42 is operating in the third operation state, the method 100 proceeds to block 132.

At block 132 (“Quality Metric Satisfied?”), the method 100 determines if a quality metric corresponding to the third operational state is being satisfied. In one example, the quality metric for block 132 includes determining if the video is being clipped or buffered. If the video corresponding to the third operational state at block 130 is not being clipped or buffered, the method 100 proceeds to block 126 and takes no action to change an operating parameter or ruleset for the electronic device 42. If the quality metric at block 132 is not satisfied, the method 100 returns to block 104 and determines if changes to the wireless transmission power needs to be dynamically adjusted or if the ruleset for the wireless device 42 need to be changed. The method 100 can continue in this manner until the wireless hub 40 is deactivated or there are not more electronic devices connected to it.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of operating a wireless ecosystem, the method comprising:
connecting a plurality of electronic devices each having a wireless communications module with a wireless hub;
querying the plurality of electronic devices with incremental variations in wireless hub transmission power to determine a reduced hub transmission power for the wireless hub sufficient to communicate with the plurality of electronic devices;
providing to each of the plurality of electronic devices an assigned wireless transmission power for communicating with the wireless hub; and
transmitting the assigned wireless transmission power from the wireless hub to each of the plurality of electronic devices for communicating with the wireless hub.

2. The method of claim 1, including determining if any of the plurality of electronic devices operating at the assigned wireless transmission power are unable to communicate with the wireless hub and transmitting a revised wireless transmission power to any of the plurality of electronic devices that are unable to communicate with the wireless hub at the assigned wireless transmission power.

3. The method of claim 1, wherein at least one of the plurality of electronic devices communicates with the wireless hub through forming an intermediate wireless connection with another one of the plurality of electronic devices.

4. The method of claim 1, including monitoring at least one of the plurality of electronic devices for a performance metric during an operational state and dynamically adjusting the assigned wireless transmission power based on comparing the performance metric during the operational state to a predetermined threshold value.

5. The method of claim 4, wherein the operational state includes a phone call and the performance metric includes an audio quality.

6. The method of claim 4, wherein the operational state includes audio streaming and the performance metric includes a measurement of clipped audio or buffered audio.

7. The method of claim 4, wherein the operational state includes video streaming and the performance metric includes a measurement of clipped video or buffered video.

8. The method of claim 1, wherein the plurality of electronic devices include at least one battery power electronic device and at least one wired electronic device configured to receive power from a power receptacle.

9. The method of claim 1, wherein the assigned wireless transmission power is determined based on at least one of a type of electronic device, a location of each of the plurality of electronic devices relative to the wireless hub, and a power source for each of the plurality of electronic devices.

10. The method of claim 1, wherein the incremental variations include reductions by predetermined percentage in the wireless hub transmission power between sequential querying of the plurality of electronic devices.

11. The method of claim 10, wherein the reduced hub transmission power includes a previous one of the incremental variation in the wireless hub transmission power that resulted in a confirmation message from each of the plurality of electronic devices.

12. The method of claim 1, wherein connecting the plurality of electronic devices with the wireless hub includes pairing the plurality of electronic devices with the wireless hub and collecting operating parameters for each of the plurality of electronic devices.

13. A wireless hub comprising:
a housing;
a wireless communication module located within the housing; and
a controller located within the housing and in electrical communication with the wireless communication module, wherein the controller is configured to:
connect a plurality of electronic devices each having a wireless communications module with a wireless hub;
query the plurality of electronic devices with incremental variations in wireless hub transmission power to determine a reduced hub transmission power for the wireless hub sufficient to communicate with the plurality of electronic devices;
provide to each of the plurality of electronic devices an assigned wireless transmission power for communicating with the wireless hub; and
transmit the assigned wireless transmission power from the wireless hub to each of the plurality of electronic devices for communicating with the wireless hub.

14. The wireless hub of claim 13, wherein the controller is confirmed to determine if any of the plurality of electronic devices operating at the assigned wireless transmission power are unable to communicate with the wireless hub and transmit a revised wireless transmission power to any of the plurality of electronic devices that are unable to communicate with the wireless hub at the assigned wireless transmission power.

15. The wireless hub of claim 13, wherein the controller is configured to monitor at least one of the plurality of electronic devices for a performance metric during an operational state and dynamically adjust the assigned wireless transmission power based on comparing the performance metric during the operational state to a predetermined threshold value.

16. The wireless hub of claim 13, wherein the assigned wireless transmission power is determined based on at least one of a type of electronic device, a location of each of the plurality of electronic devices relative to the wireless hub, and a power source for each of the plurality of electronic devices.

17. The wireless hub of claim 13, wherein the incremental variations include reductions by predetermined percentage in the wireless hub transmission power between sequential querying of the plurality of electronic devices.

18. The wireless hub of claim 17, wherein the reduced hub transmission power includes a previous one of the incremental variation in the wireless hub transmission power that resulted in a confirmation message from each of the plurality of electronic devices.

19. The wireless hub of claim 18, wherein connecting the plurality of electronic devices with the wireless hub includes pairing the plurality of electronic devices with the wireless hub and collecting operating parameters for each of the plurality of electronic devices.

20. A vehicle comprising:
a body at least partially defining a passenger compartment with the body supported by a plurality of wheels;
a wireless hub located within the body and configured to communicate with a plurality of electronic devices within or surrounding the vehicle, wherein the wireless hub includes a controller configured to:
connect a plurality of electronic devices each having a wireless communications module with a wireless hub;
query the plurality of electronic devices with incremental reductions in wireless hub transmission power to determine a reduced hub transmission power for the wireless hub sufficient to communicate with the plurality of electronic devices;
provide to each of the plurality of electronic devices an assigned wireless transmission power for communicating with the wireless hub; and
transmit the assigned wireless transmission power from the wireless hub to each of the plurality of electronic devices for communicating with the wireless hub.
